(19) United States
(12) Patent Application Publication
(10) Pub. No.: US 2024/0127284 A1
(43) Pub. Date: Apr. 18, 2024

(54) ATTRIBUTING IN-STORE VISITS TO MEDIA CONSUMPTION BASED ON DATA COLLECTED FROM USER DEVICES

(71) Applicant: Foursquare Labs, Inc., New York, NY (US)

(72) Inventors: David Shim, Seattle, WA (US); Elliott Waldron, Seattle, WA (US); Weilie Yi, Carlsbad, CA (US); Nick Gerner, Seattle, WA (US); George Varghese, Kirkland, WA (US); Andrea Eatherly, New York, NY (US)

(73) Assignee: Foursquare Labs, Inc., New York, NY (US)

(21) Appl. No.: 18/235,624

(22) Filed: Aug. 18, 2023

Related U.S. Application Data
(63) Continuation of application No. 14/825,978, filed on Aug. 13, 2015, now Pat. No. 11,734,712.
(60) Provisional application No. 62/037,025, filed on Aug. 13, 2014.

(51) Int. Cl. G06Q 30/0242

(52) U.S. Cl. CPC G06Q 30/0246

(57) ABSTRACT

A system and method for attributing in-store visits to exposure to advertisement (“ad”) impressions associated with an ad campaign are disclosed. The system gathers impression data and uses that data to identify users who were exposed to the ad impressions. The system then uses location data, activity information and in some instances beacon data points reported by mobile devices of the impression users to determine if the impression users visited a target place during a conversion window. Based on the impression users who were exposed to the ad impressions, the system establishes a control group of users who were not exposed to the ad impressions to perform quasi-experimental analyses to assess whether the ad impressions had any impact on changing the impression users' physical in-store visitation behavior.

### CROSS-REFERENCE TO RELATED APPLICATIONS

This application claims priority to U.S. Provisional Patent Application No. 62/037,025, filed on Aug. 13, 2014, entitled ATTRIBUTING IN-STORE VISITS TO MEDIA CONSUMPTION BASED ON DATA COLLECTED FROM USER DEVICES, which is hereby incorporated by reference in its entirety. This application is related to U.S. application Ser. No. 13/405,182, filed Feb. 24, 2012, U.S. application Ser. No. 13/892,201, filed May 10, 2013, U.S. application Ser. No. 13/405,190, filed Feb. 24, 2012 (U.S. Pat. No. 8,768,876), and U.S. application Ser. No. 14/300,102, filed Jun. 9, 2014, which are hereby incorporated by reference in their entirety.

### BACKGROUND

Advertisers utilize various media channels to advertise their products or services to consumers. In the online domain, for example, advertisers use emails and online advertisements (“ads”) on websites and mobile applications. A consumer typically clicks on an online ad or an email to visit the advertiser's website, make a purchase on the website or download an application. As the consumption of the online ad and engagement in a desired behavior that the advertiser is interested in occurs on the same device, the advertiser is able to know, in general, if the online ad caused the consumer to engage in the desired behavior. However, when the consumption of an ad occurs in one device and the engagement in a desired behavior occurs in another device or offline, an advertiser generally does not have an effective way of knowing whether the ad had any impact on the consumer. In some instances, an advertiser can infer that an ad may have caused a consumer to make a purchase at the advertiser's store by reconciling a record of the purchase with an email address of the consumer. However, such a method can capture only “purchase” behavior. Consequently, the advertiser would not have any knowledge of the impact of the ad on the consumer if the consumer visited the store but did not purchase anything.

### BRIEF DESCRIPTION OF THE DRAWINGS

FIG. 1 is a diagram illustrating an embodiment of a target place visitation behavior of example panelists associated with both an ad-network and the attribution system.

FIG. 2 is a block diagram illustrating panelist matching in the attribution system.

FIG. 3 is a diagram illustrating behavioral measurements of impression users of the attribution system.

FIG. 4 is a diagram illustrating a lookalike population similar to the impression population carved out from the baseline population in the attribution system.

FIGS. 5A, 5B and 5C are graphical diagrams illustrating propensity modeling in the attribution system.

FIG. 6 is a diagram illustrating example lift metrics from a causal analysis.

FIG. 7 is a diagram illustrating example index metrics from indexing analyses.

FIG. 8 is a block diagram illustrating an example architecture of the attribution system.

FIGS. 9-12 are block diagrams illustrating data file management in the attribution system.

FIG. 13 is a block diagram illustrating a core pipeline of the attribution system.

FIG. 14 is a block diagram illustrating a method of identifying impression users.

FIG. 15 is a block diagram illustrating a method of synthesizing baseline users.

FIG. 16 is a block diagram illustrating a method of generating attribution user profiles.

FIG. 17 is a diagram illustrating example attribution metrics determined or inferred by the attribution system.

FIG. 18 is a block diagram illustrating an example of an attribution data model of the attribution system.

FIG. 19 is a block diagram illustrating flexible metric aggregation in the attribution system.

FIG. 20 is a block diagram illustrating user visit or cluster data aggregation in the attribution system.

FIG. 21 is a block diagram illustrating affinity aggregation in the attribution system.

FIG. 22 is a block diagram illustrating causal aggregation in the attribution system.

FIG. 23 is a block diagram illustrating feature aggregation in the attribution system.

FIG. 24 is a block diagram illustrating attribution analysis in the attribution system.

FIGS. 25-26C are diagrams illustrating example attribution reports generated for an ad campaign.

FIG. 27 is a block diagram illustrating the web service and database components of the attribution system.

FIG. 28 is a block diagram illustrating attribution monitoring in the attribution system.

FIG. 29 is a block diagram illustrating a process of performing attribution analysis to generate an attribution report.

FIG. 30 shows a diagrammatic representation of a machine in the example form of a computer system within which a set of instructions, for causing the machine to perform any one or more of the methodologies discussed herein, may be executed.

### DETAILED DESCRIPTION

The attribution system disclosed herein ties advertisement (“ad”) impressions to visits to target places to provide advertisers one or more metrics characterizing the effectiveness of the ad impressions. Based on impression data associated with an ad campaign and geolocation data collected directly from a panel of mobile electronic device (“mobile device”) users (“panelists”), the attribution system attributes a real-world, physical visit to a target place to exposure to the ad impression. In many instances, the attribution is a function of time elapsed between the exposure to the ad impression and the physical visit to the target place. A place, as used herein, includes any physical establishment, for example, a restaurant, a park, a store, a gas station, etc.

The attribution system, in some embodiments, leverages a data collection system to obtain user information, including location data, collected directly from the panelists. The data collection system obtains and validates location data from the panelists. The user information collected by the data collection system includes, for example, latitude, longitude, altitude determinations, sensor data (e.g., compass/bearing data, accelerometer or gyroscope measurements), and other information that can be used to identify a panelist's location and activity. Additional details on the data collection system can be found in U.S. patent application Ser. No. 13/405,182 (Attorney Docket No. 076347-8001.US00), which is hereby incorporated by reference in its entirety.

In some embodiments, the data collection system may receive, obtain, or access information from third party sources in order to enhance or modify attribution metrics for ad impressions. For example, a third party source of data, such as a payment processor or social network, may provide data confirming a purchase or use of a product or service associated with an ad impression. Such purchase or use information may, therefore, augment the data associated with an ad campaign and the geolocation data collected directly from the panel of mobile electronic device users.

In some embodiments, the attribution system may receive, obtain, or access information from third party sources in order to measure purchase data from a larger population of users, such as any users associated with a third party source. For example, the attribution system may utilize purchase or use data directly from the third party sources (e.g., data indicating a user or group of users made a purchase of a product or service at a certain location, via a certain retailer, and so on) as attribution for ad impressions.

The attribution system, in various embodiments, also leverages an inference pipeline that recognizes, based on location readings, whether a user visited a target place, and if so, determines the probability of the user at the target place and how much time the user spent at the target place. Additional details on the inference pipeline can be found in U.S. Pat. No. 8,768,876 (Attorney Docket No. 076347-8002.US00) which is also hereby incorporated by reference in its entirety.

In some embodiments, the process of attributing a visit to a target place starts with an advertiser (e.g., a mobile advertiser HMC) delivering ads (e.g., mobile ads, desktop ads, television ads) through an ad-network to a group of users on their devices (e.g., mobile devices, desktop computers, television, voice telephony, tablets, mobile gaming devices, smart phones) as part of an ad campaign. In other embodiments, ads may be delivered to, or accessed by, the group of users via other media types, such as via print, billboards, radio, and others described herein.

These users who receive the ad impressions form a campaign population. The advertiser or the ad-network provides impression data and details of the ad campaign to the attribution system. The impression data can include, for example, device identifiers, impression timestamps, targeting identifiers, and other metadata associated with the campaign or the target of the impression. For example, the metadata may include user agent strings and segment identifiers. The attribution system then uses the device identifier, IP address, device model, operating system version and/or any other metadata to match the campaign population against the panelists of the attribution system to identify panelists who were exposed to the ad impressions (“impression population”). In some embodiments, impression data can be collected by the attribution system.

After identifying the impression population based on the match, a baseline population is constructed in one of two ways. First, the advertiser may provide an indicator within the impression population that codes for membership in a control group (e.g., those impressions associated with no advertisement or the presentation of an unrelated advertisement). When no control group is specified, the attribution system identifies the panelists who did not match and includes them into a baseline or control group. The attribution system then performs experimental analysis to assess whether the ad impression had any impact on changing the impression users' physical store visitation behavior. In some embodiments, the attribution system can perform other analyses. For example, the attribution system can determine metrics such as costs per store visit, frequency of store visits, likelihood of store visits for different geography and demographics, or the like. These and other metrics from the analyses enable advertisers to make adjustments to their ad campaigns to improve performance (e.g., increase store visits, target certain demographics). The metrics generated by the attribution system also describe or characterize the nature of the ad campaign run by advertisers.

Various embodiments and implementations of the attribution system will now be described. The following description provides specific details for a thorough understanding and an enabling description of these embodiments and implementations. One skilled in the art will understand, however, that the embodiments and implementations may be practiced without many of these details. Additionally, some well-known structures or functions may not be shown or described in detail, so as to avoid unnecessarily obscuring the relevant description of the various embodiments and implementations. The terminology used in the description presented below is intended to be interpreted in its broadest reasonable manner, even though it is being used in conjunction with a detailed description of certain specific embodiments and implementations of the attribution system. It should be noted that although the present disclosure provides specific examples of analyses for attributing consumption of media (e.g., ads) to a physical store visitation, other analyses can be utilized by the attribution system for the same purpose. For example, any causal estimation techniques, regression analyses, etc. can be used by the attribution system to attribute consumption of media (e.g., ads) to a physical store visitation.

### 1. Overview

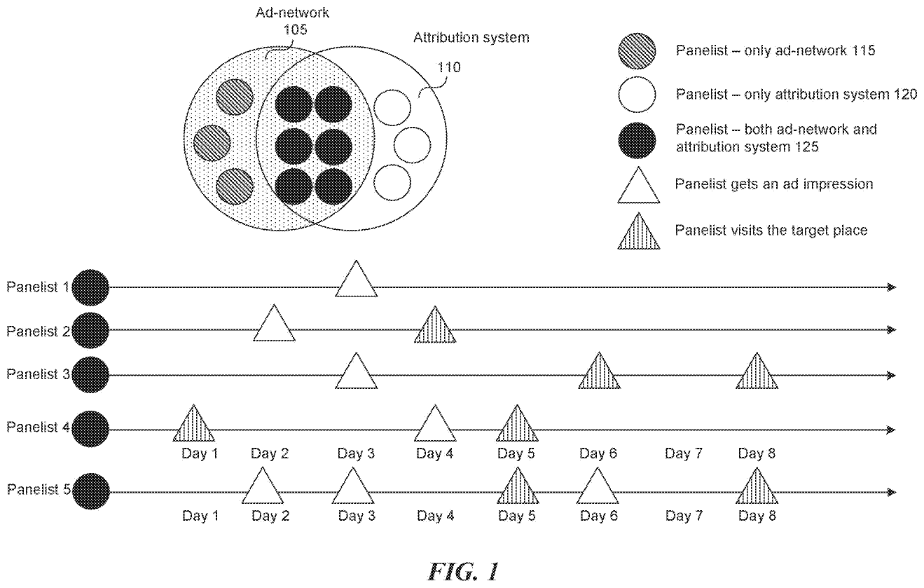

FIG. 1 is a diagram illustrating target place visitation behavior of four example panelists associated with an ad-network 105 and the attribution system 110. In FIG. 1, panelists 115 and 125 are associated with the ad-network 105 and receive an ad impression relating to an ad campaign. Panelists 120 and 125 are panelists of the attribution system 110. Some of the panelists of the attribution system (e.g., 120) receive no ad impressions, while other panelists (e.g., 125) of the attribution system match or overlap with the panelists of the ad-network and receive an ad impression relating to the ad campaign.

The attribution system analyses location and other activity information relating to panelists 125 of the attribution system who receive the ad impression over a window of time to determine or infer whether the panelists 125 visit a target place and probabilities of the visit. For example, the attribution system can determine or infer, based on location and/or other user information, that panelist 1 who receives an ad impression on day-3 does not visit the target place during the window of time (e.g., 5 days starting from the date of impression). Similarly, the attribution system can determine or infer that panelist 2 who receives an ad impression on day-2, visits the target place on day-4. In the case of panelist 3, he or she visits the target place on day-6 and day-8 after receiving an ad impression on day-3, while panelist 4 visits the target place 3 days before the ad impression and again one day after the ad-impression. The attribution system uses various models and analyses on the impression and baseline user impressions to determine if an exposure to ad impressions associated with the campaign caused the impression users to visit the target place during the window of time. In some embodiments, a multiple attribution method can be used to credit one or more impressions to a visit. For example, as illustrated in FIG. 1, panelist 5 receives an ad impression on day-2 and day-3 and visits the target place on day-5. Panelist 5 then sees an additional ad impression on day 6 and visits the target place on day-8. In this scenario, by using the multi attribution method, credit for the conversion (e.g., two visits to the target place) can be split across the ad impressions received on day-2, day-3 and day-6.

Thus, in some embodiments, the attribution system receives an indication that a mobile device has entered a target geographical location associated with a campaign, and determines a campaign impression for the campaign occurred at the mobile device within a certain time period before the mobile device entered the target location.

1a. Panelist Matching and Baseline Creation

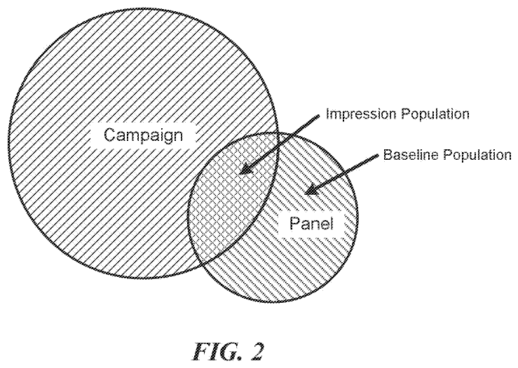

FIG. 2 is a block diagram illustrating panelist matching in the attribution system. The panelist matching is performed to identify panelists of the attribution system who were exposed to ads associated with an ad campaign. In various embodiments, matching is based on identifiers, for example, hashed device identifiers. The hashed device identifiers from the campaign population are matched against the hashed device identifiers of the panelist population. The overlap between the campaign population and the panelist population is the impression population.

In the case where no baseline or control group is provided by the advertiser, the population of nonmatching panelists forms the baseline population. The baseline population can be used as a basis for measuring the success of the ad campaign. Panelists in the baseline population are assigned simulated impression times in the same distribution as was observed in the impression population, unless the control group impression times are explicitly provided by the advertiser. Thereafter, the baseline population is analyzed in the same manner as the impression population with respect to the simulated impression times. When the control impression times are not provided by the advertiser, this process of randomly assigning simulated impression times to the baseline panelists ensures that any calendar seasonalities (e.g., weekday, end of month, time of day) effects are the same between the impression and baseline populations.

1b. Behavior Measurement

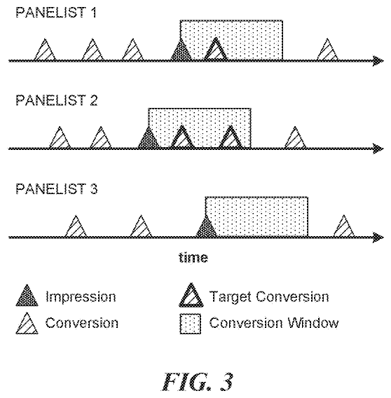

The attribution system measures various metrics. One such metric is the in-store conversion rate (e.g., average number of visits across users) for the target place that was the focus of the ad campaign. This conversion rate is measured in the context of a conversion or time window. A conversion window is a window in time that starts just after the ad impression and ends as a later time. Different places can have different conversion windows. For example, a place that is visited weekly can have a 7-day conversion window (e.g., a grocery store), whereas a place that is usually visited on a monthly basis may have a 30 day conversion window (e.g., a mattress store). Conversion rates are computed over various widows in the period after the first impression or the most recent impression. The schematic of FIG. 3 depicts how conversions are captured in a conversion window for three example panelists. In FIG. 3, panelist 1 has one conversion event in the conversion window. Panelist 2 has two conversion events, and panelist 3 has no conversion events in the conversion window. In some embodiments, a multiple method can be used in calculating conversion rates. The multiple method weights the assignment across multiple ad impressions responsible for a visit.

1c. Propensity Scoring

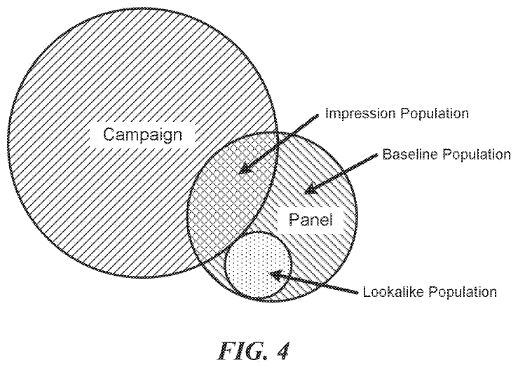

Often, an advertiser carries out an ad campaign to target a specific audience. For example, an ad for a retail pharmacy may be targeted to an older population (e.g., 50-65 year olds). When a control population is provided by the advertiser, measuring ad effectiveness is done by directly comparing conversion rates for the impression group and the baseline or control group. When the baseline is constructed from the population of non-matched panelists, the method of Propensity Scoring (or lookalike modeling) can be used to adjust the baseline population so that it looks like the impression population. FIG. 4 is a diagram that depicts the attribution system carving out a lookalike population in the baseline population that is similar to the impression population.

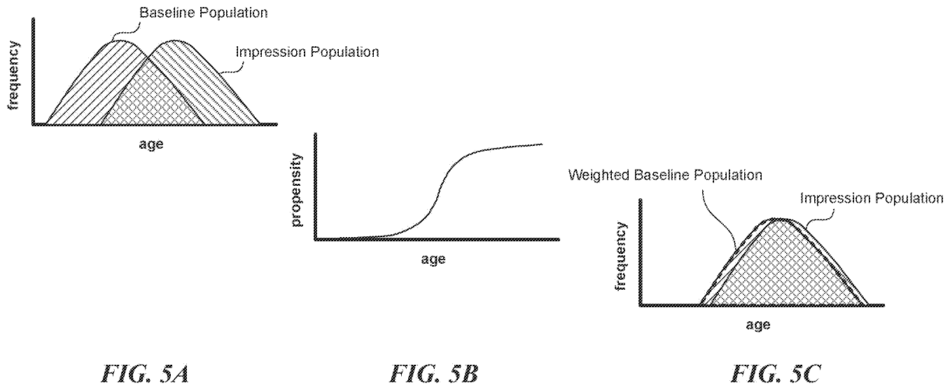

Propensity scoring models the differences between the impression and baseline populations. A propensity model can use demographic, geographic and/or behavioral attributes to model the impression population. For example, the impression population may be comprised of panelists who are generally older than the current population as is shown in the graphical diagram of FIG. 5A. In the graph of FIG. 5A, age is plotted against a frequency of occurrence for both the impression population and the baseline population. The impression population has relatively more older panelists, whereas the baseline population has relatively more younger panelists. The process of propensity scoring generates weights that make the characteristics of the baseline population match the characteristics of the impression population. For the case of a single distinguishing characteristic, the propensity scores can be similar to the graph illustrated in FIG. 5B. The graph of FIG. 5B shows that older panelists have a higher propensity for belonging to the impression group than the younger panelists. These propensities are generated across the baseline population and then used to weight the baseline population so that the age distribution approximately matches the impression population. Once the impression and baseline populations are matched, any remaining difference in conversions can be assumed to be due to the ad exposure. For example, in FIG. 5C, the frequency of occurrence is plotted against age for both the impression and weighted baseline populations and depicts the difference in conversions between the two populations.

The propensity scoring process described above was based on a propensity model that considered a single characteristic (e.g., age). A similar propensity scoring process can be used to determine a propensity score based on a propensity model that considers multiple characteristics (e.g., gender, age group, geographical location). The output from the propensity model is a propensity score that is used to reweight the baseline population so that the reweighted baseline population has similar characteristics to the impression population.

1d. Lift Analysis

Lift analysis is one of the analyses performed by the attribution system to assess the effect of an ad in driving in-store visits at a higher rate for the users who received the ad impression. Lift is defined as the relative difference in the conversion rates between the impression and baseline populations. Three distinct conversion rates can be used to compute three types of lift:
(1) Baseline Conversion Rate (CR_{B}): the conversion rate of panelists not exposed to the ad.
(2) Adjusted Baseline Conversion Rate (CR_{B*}): the baseline conversion rate after adjusting for targeting effects via propensity modeling.
(3) Impression Conversion Rate (CR_{I}): the conversion rate of panelists exposed to the ad

The three types of lift are then defined as follows:

$$\begin{matrix}( 1 ) Total Lift : \frac{{CR}_{1}}{{CR}_{B}} - 1 \\ ( 2 ) Targeting Lift : \frac{{CR}_{{B}^{*}}}{{CR}_{B}} - 1 \\ ( 3 ) Casual Lift : \frac{{CR}_{1}}{{CR}_{{B}^{*}}} - 1\end{matrix}$$

Total Lift is the relative difference in the conversion rates between the impression and baseline populations before any propensity adjustment. Thus, Total Lift combines the effects of targeting as well as any changes in visitation behavior caused by the advertisement.

Targeting Lift measures the impact of targeting a specific set of users (e.g., “soccer moms”) versus no targeting at all. Depending on whether the targeting group already has a high or low prior likelihood of making a target visit, targeting lift can be positive or negative.

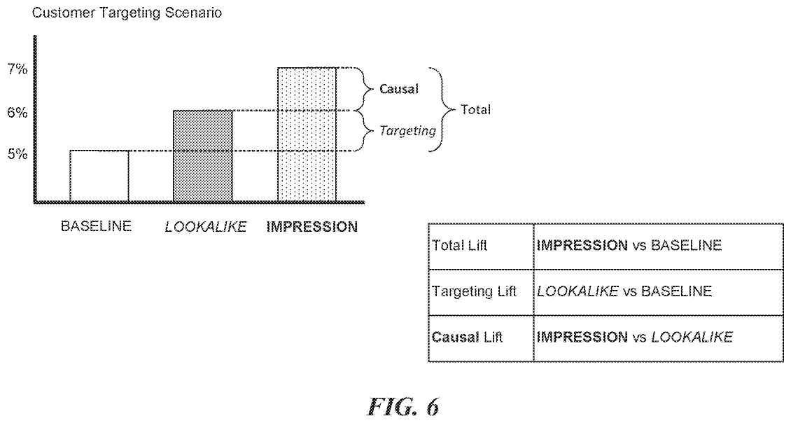

Causal Lift is considered to only be a result of the ad impression, after effects of targeting are removed. By way of an example, consider the pharmacy example above where an older population was targeted for an ad. As shown in the graphical diagram of FIG. 6, the baseline conversion rate (CR_{B}) was 5%. After accounting for the older population, the adjusted baseline conversion rate (CR_{B*}) was 6%. Finally, the conversion rate observed in the impression group (CR_{I}) was 7%. Based on these conversion rates, the following lift metrics can be calculated:

$$\begin{matrix}( 1 ) Total Lift : 40 \% ( \frac{7}{5} - 1 ) \\ ( 2 ) Targeting Lift : 20 \% ( \frac{6}{5} - 1 ) \\ ( 3 ) Casual Lift : 16 \% ( \frac{7}{6} - 1 )\end{matrix}$$

In this example, we can assume that the ad drove an extra 16% in conversions, after accounting for the effects of targeting ad recipients based on age.

1e. Indexing Analysis

In some embodiments, the attribution system can segment populations based on various characteristics. Example characteristics can include but are not limited to: gender, age, income, children, relationship status, ethnicity, education, geography, presence of specific mobile applications, or the like. Additional characteristics can be derived from these base characteristics to create like segments of populations, such as ‘sports enthusiasts’ or ‘business travelers’. The attribution system can then perform an indexing analysis on any segmented population, geography and business to determine a corresponding index. Examples of index metrics determined from the indexing analysis include an impression index and a place index for different segments. The impression index provides a measure of differences between population with impression and baseline population. The place index measures the differences between the impression and baseline populations among panelists who visited the target place after viewing an ad.

These indexes enable advertisers to know if their ads effectively reached the targeted audience or if their ads were targeted to particular demographic segments, and make specific adjustments if necessary. For example, if an ad campaign was targeted to users in the West Coast more than the East Coast, a high (low) geographic index for the West Coast indicates that the impression population included relatively more (fewer) people from the West Coast than the baseline population and was thus successfully targeted to (away) users in the West Coast. Similarly, a high impression index for females would be an indication that the ad campaign was more effective at reaching females than males.

In some embodiments, the attribution system, as part of collecting user information from panelists, can collect information relating to applications that are installed on the panelists' mobile devices. The attribution system can then report to advertisers an application index that enables the advertisers to know that their ad campaigns were effective among users with certain types or specific applications in their mobile devices. For example, a high FACEBOOK index for the impression group can indicate that the users with the FACEBOOK application on their mobile devices were more receptive to ad impressions. This information can then be used by the advertiser to advertise through the FACEBOOK application, for example.

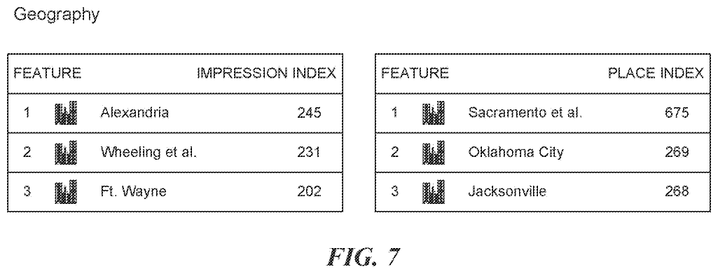

In some embodiments, the attribution system can also calculate an opportunity index or report for advertisers. The opportunity index provides advertisers with information on the geographic regions, demographics and applications that could be targeted in the next ad campaign that will increase lift. Some example index metrics are illustrated in FIG. 7.

### 2. Example Architecture of the Attribution System

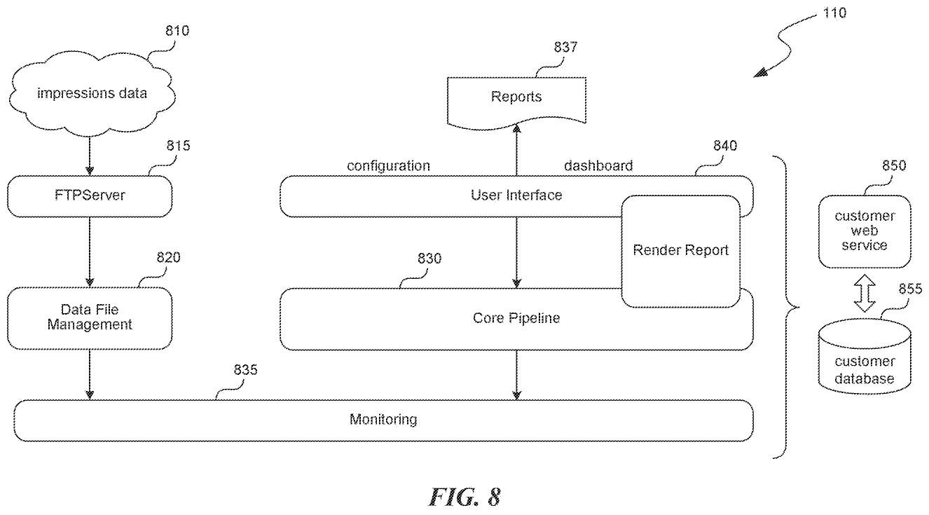

FIG. 8 is a block diagram illustrating an example architecture of an attribution system 110. In some embodiments, the attribution system 110 receives impression data 810 from third-parties such as advertisers, ad-networks, etc. In some embodiments, the impression data can be collected by an agent of the attribution system. In other embodiments, some impression data can be received from third-parties and some impression data can be collected by the attribution system. Impression data from third-parties can be uploaded to the attribution system via an FTP server 815 or delivered to a proprietary server by using embedded code (e.g., a ‘pixel’ tag, or other industry standard method of passing data via a web service) within the ad. The impression data then flows through a data file management component 820 for initial processing and a core pipeline 830 for further analyses.

A monitoring component 835 monitors the progress of impression data processing to trigger an alert to the core pipeline that impression data is available for analyses. The monitoring component 835 also monitors the output from the core pipeline 830 to render reports 837 and update a user interface 840 to allow customers access to the reports. A web service 850 provides customers access to reports and/or other data from the analyses stored in a customer database 855.

The attribution system 110, therefore, may include an impression component that receives campaign impression data associated with media consumption at multiple mobile devices during a campaign, a location visit component that determines whether one or more of the multiple mobile devices visit a geographical location associated with the campaign within a time window for the campaign, and an attribution component that identifies occurrences of conversion events for the campaign when the one or more mobile devices visit the geographical location associated with the campaign within the time window for the campaign.

Each of the components will now be described in detail.

2a. Data File Management

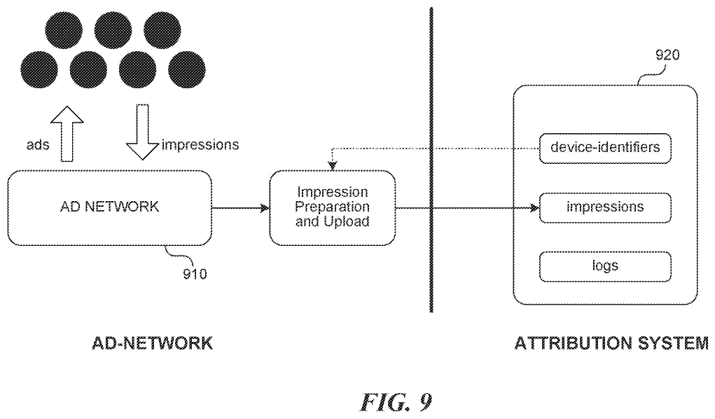

FIGS. 9-12 are block diagrams illustrating processes performed by the data file management component 820 in the attribution system 110. Referring to FIG. 9, an ad-network 910 sends ads to devices 920 of users and in return, obtains one or more pieces of content or impression data from the devices 920 of the users. The impression data informs the attribution system 110 who got what and when. For example, impression data for an ad campaign can inform the attribution system 110 that device A got a HMC store ad at 3:18 pm on 2014 Mar. 1. Thus, impression data generally includes the following pieces of information:
1. a unique identifier to identify a device, usually a device identifier (deviceid), cookie, user-agent string, etc., and can be hashed for privacy;
2. a sub-placement identifier to determine what the impression was about; and
3. a timestamp of the impression to indicate the timestamp in second of when a user got the impression.

If the impression data is provided in a flat file, it is prepared and can be uploaded to the FTP server of the attribution system. In some embodiments, preparing the impression data can include hashing the device identifiers or other information for privacy reasons, so that only hashed device identifiers are provided to the attribution system. In some embodiments, the ad network can provide impression data to the attribution system by uploading the impression data to file storage/sharing services (e.g., GOOGLE DOCS, DROPBOX, AMAZON S3) or sending the impression data via email. Each upload event can be logged in a log at the FTP server 815. In some embodiments, impression data can be passed in real-time as the ad is served (via embedded code within the ad).

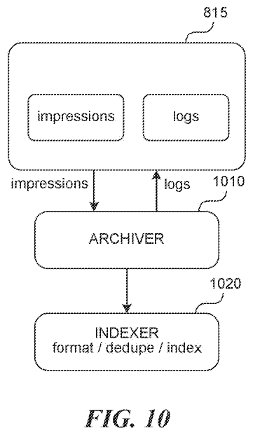

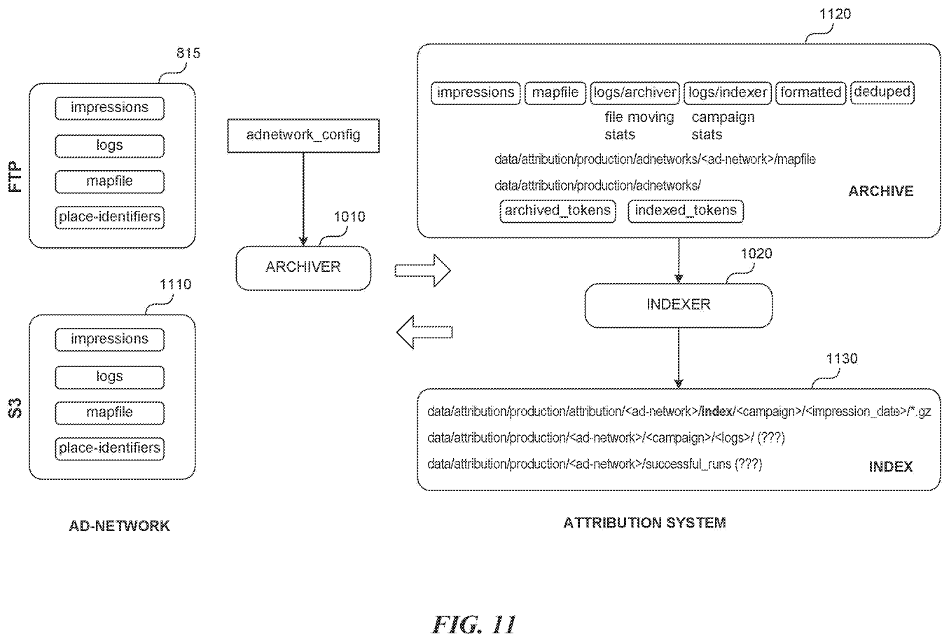

The attribution system stores the impression data in one or more databases or database tables. In some embodiments, for cheaper and/or scalable storage and easy retrieval during processing, the attribution system can archive and index the impression data using an archiver 1010 and an indexer 1020, respectively, as depicted in FIG. 10. The indexer 1020 can use sub-placement-id and timestamp to index the impression data for efficient retrieval of impression data.

Referring to FIG. 11, the FTP server 810 or another location (e.g., cloud-based storage) 1110 where the impression data is uploaded can include impressions, as well as other files such as logs, mapfile and device-identifiers. To process the files, the attribution system 110 reads configuration data associated with the ad-network to determine active networks. The attribution system then generates processing-id (e.g., timestamp) and sets up destination folders where the processed impression data is to be stored. All files from the source, including impressions and mapfiles are copied to the destination archive 1120 and the action is logged in archiver logs in the destination. Once the files are successfully copied, the files at source are deleted, and an archived token is created with processing-id as file-name and processing-id and path to destination as content. Then an acknowledgement is written to a source log.

After archiving, the impressions are formatted, deduped and indexed. Formatting can include applying custom network formatter on impressions and persisting the formatted data. Deduping can include applying a key (e.g., device-id, campaign and timestamp triplet) to eliminate duplicates from archive-formatted and indexed-impressions. The deduped impressions can then be indexed by impression date in an index 1130. The archive logs are then updated to record the move and other statistics. After successfully moving the data, indexed tokens are created.

The file processing continues, by reading the indexed tokens from recent runs. For each token, the file processing pipeline copies archive logs from the destination to the source and then deletes the index token. Following deletion, an acknowledgement is written to the source log and the “successful_runs” log is updated.

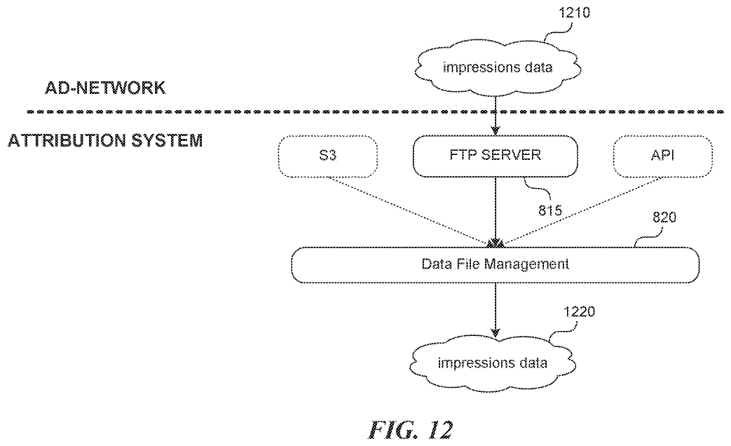

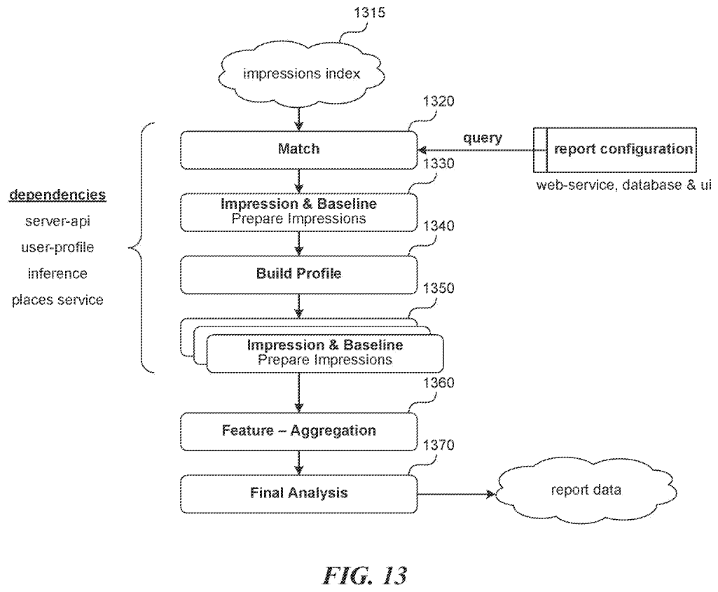

Referring to FIG. 12, the data file management process is illustrated, with the data file management component being a point of integration between the attribution system and external ad-networks. As explained above, the impression data from ad-networks are directly uploaded 1210 to the FTP server 815 or cloud-based storage or transmitted using API or other channels to the attribution system 110. The data file management component pulls the impression data and processes the impression data by formatting, deduping and indexing 1220 for efficient storage and retrieval of the impression data.

2b. Core Pipeline

The core pipeline of the attribution system is illustrated in FIG. 13. As illustrated, the core pipeline has several dependencies including, for example, server-api, user profile, inference, and place service. These dependencies are described in detail in U.S. patent application Ser. No. 13/405,182 and U.S. Pat. No. 8,768,876.

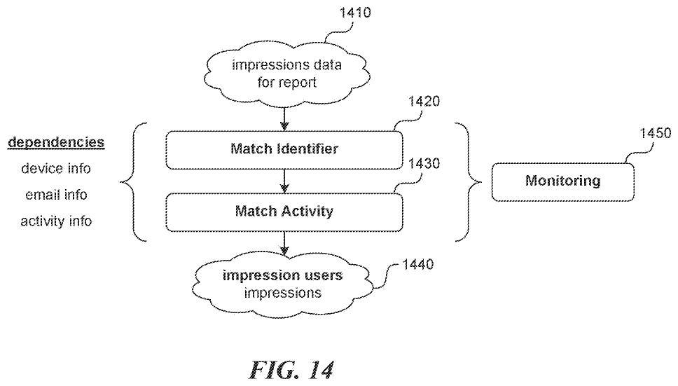

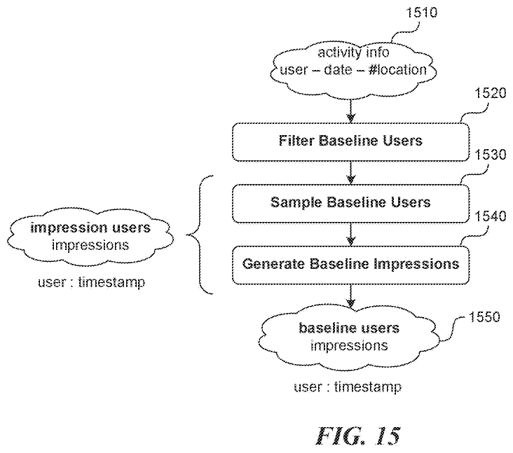

Referring to FIG. 13, the core pipeline receives a web service query 1310 including report configuration parameters. The query triggers retrieval and processing of impression data associated with an ad campaign. Based on the report configuration parameters (e.g., placement id, sub-placement id, conversion window), the core pipeline retrieves impressions data 1315 associated with the campaign. The core pipeline then performs a match 1320 against the panelists of the attribution system to identify impression users 1330 who were exposed to the impressions associated with the campaign and baseline users who were not exposed to the impressions. The matching process is described in detail in reference to FIG. 14 and the method of synthesizing baseline users is described in detail in reference to FIG. 15.

The core pipeline then builds attribution profiles 1340 for each user in the impression or the baseline group by joining the impression data associated with the user with their existing user profile, and performs user aggregation 1350 and feature aggregation 1360. A user profile can include information such as demographics (e.g., age, gender, income level, ethnicity, education, marital status, number of children, etc.), mobile device information, user location history, distance to home location, distance to work location, commute patterns, device features (e.g., manufacturer, model, service provider, sensor availability, etc.), frequently visited places in the past and/or other information that can help predict where a user is visiting.

In some embodiments, the user profile and/or attribution profile 1340 may include or be enhanced by information received from users in response to surveys or polls asked or provided to users. For example, information received via a survey (e.g., information about what movie a user watched in a movie theatre), such as survey data, may provide additional conversion data attributed to a user, other than directly measured data, such as location visits (e.g., what movie theatre the user visited) and other geographical data.

As described herein, various types of information may be obtained via user surveys, such as user preference data, user purchasing data, user choice data, user interest data, and so on. The data collection system, therefore, may utilize various types survey and poll questions when obtaining information from users. Following the movie theatre example, a user survey targeted to a user at a movie theatre may include the following questions:
Questions directed to purchasing habits—e.g., “Did you buy the tickets?”, “How did you buy the tickets?”, “Did you buy refreshments?”, and so on;
Questions directed to purchasing information—e.g., “How much did the tickets cost?”, “When did you see the movie?, and so on;
Questions directed to user preferences or interests—e.g., “Did you enjoy the movie?”, “Was the movie your first choice?”, and so on;
Questions directed to user habits or actions—e.g., “Did you drive to the theatre?”:Did you go to dinner before or after the movie?” “Did you go to other places while out?”, and so on.

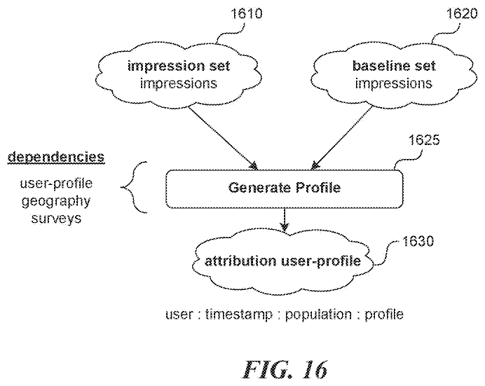

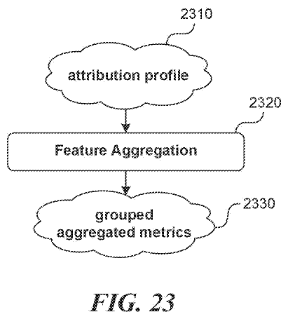

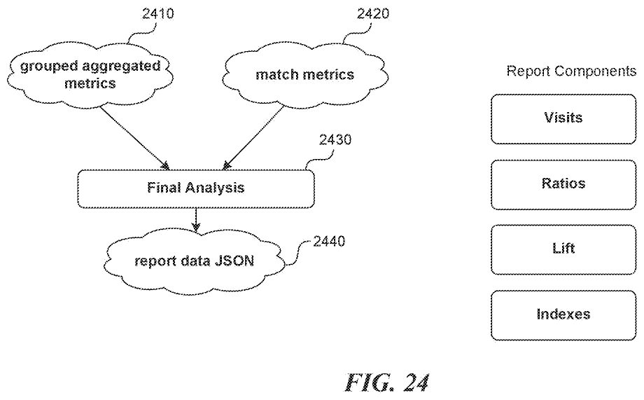

FIGS. 16-18 depict the example embodiments of the attribution profile, aggregation metrics, and full data model. The core pipeline then performs various analyses 1370, including cluster analysis, affinity analysis and causal analysis to aggregate metrics at the user level. These analyses are described in detail with reference to FIGS. 19-22. The aggregated metrics at the user level are then aggregated over one or more features to obtain grouped aggregated metrics. The process of aggregating metrics over one or more features are described with reference to FIGS. 23 and 24. The core pipeline then performs an attribution analysis to generate the various metrics associated with an attribution report such as conversion rates, lift and indexes. The process of performing the attribution analysis is described in detail with reference to FIG. 24.

FIG. 14 is a block diagram illustrating a method of identifying impression users implemented by the core pipeline of the attribution system 110. The core pipeline retrieves impression data 1410 associated with a campaign from a database. The core pipeline then matches 1420 hashed device identifiers from the impression data against hash device identifiers of the panelists of the attribution system to identify impression users. In some embodiments, the core pipeline can also match activity 1430 so that the impression users that are selected are active users (e.g., users who are responsive to surveys, users with devices that have been reporting location data, etc.). The impression users and impressions (e.g., user id: timestamp) are then stored 1440 for further processing. The generation of match metrics (e.g., impression users and impressions) are monitored 1450 by the monitor of the attribution system to create alerts for the web service and user interface components.

FIG. 15 is a block diagram illustrating a method of synthesizing baseline users from the panelists of the attribution system who are not among the impression users. The core pipeline can retrieve activity information (e.g., user id, date, number of locations) 1510 and use one or more filter criteria to filter baseline users 1520. Example filter criteria can include, but are not limited to: panelists who are not in the impression set, who are active during campaign, who have responded to surveys, who have cluster activity, or the like. The core pipeline can then sample the baseline users 1530. In some embodiments, by default 100,000 baseline users may be selected. The core pipeline then generates baseline impressions 1540 by sampling timestamps from the impressions users and assigning simulated impression times in the same distribution as was observed in the impression users. The baseline users and impressions (e.g., user id: timestamp) are then stored 1550 for further processing.

FIG. 16 is a block diagram illustrating a method of generating 1625 attribution user profile by joining impression set impressions 1610 and baseline set impressions 1620 with user-profile 1630, geography, and/or surveys. An attribution user-profile record stores 1640 associations between user id, timestamp, population (e.g., impression or baseline) and user profile.

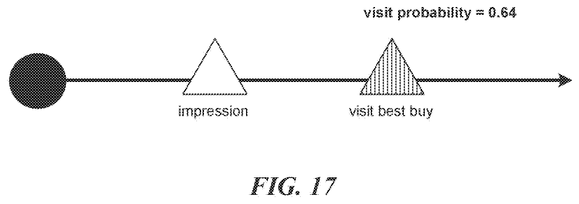

The attribution system generates various attribution metrics that are stored in association with attribution user-profile records (or attribution profile records). FIG. 17 is a diagram illustrating example attribution metrics determined or inferred by the attribution system. Some examples of attribution metrics and their definitions are listed below in Table 1. These metrics are generated as results of the various analyses performed by the core pipeline.

TABLE 1
Example Attribution Metrics

| Attribution Metrics | Definition |
|---|---|
| p_target | Probability of a visit to a target place (e.g., BESTBUY |
| | store) or a visit to a target place which sells a particular |
| | product, after receiving an impression and within the |
| | conversion window |
| p_anywhere: | Probability of a visit to any place after receiving an |
| | impression and within the conversion window |
| cluster_count | Number of clusters captured within a conversion window |
| visitor_days_target | The number of visits to a target place after receiving and |
| | impression and within the conversion window |
| visitor_days_anywhere | The number of visits to any place after receiving an |
| | impression and within the conversion window |
| Propensity or propensity score | Output from a propensity model to account for differences |
| | between an impression population and a baseline |
| | population |
| expected_impression_response | Predicted conversion rate assuming the user was exposed to |
| | an ad |
| expected_baseline_response | Predicted conversion rate assuming the user was not |
| | exposed to an ad |
| expected_impression effect | Difference between mean of expected_impression_response |
| | for the impression population and mean of |
| | expected_baseline_response for the baseline population |
| expected_baseline_effect | Mean of expected_baseline_response for the baseline |
| | population |
| double_robust_residual | The error in the doubly robust estimate of the causal effect, |
| | used for computing a confidence interval |
| p_affinity_overlap | The probability that the user visited both the target place |
| | and some other predefined place within the conversion |
| | window |
| p_index_overlap | The probability that the user visited both the target place |
| | and some other predefined feature including, but not |
| | limited to, geography, demographic, device, wireless |
| | carrier, operating system, time of day, day of week, within |
| | the conversion window |
| p_purchase | Purchases tied to store visits attributable to ad impressions |
| p_revenue | Revenue tied to store visits attributable to ad impressions |

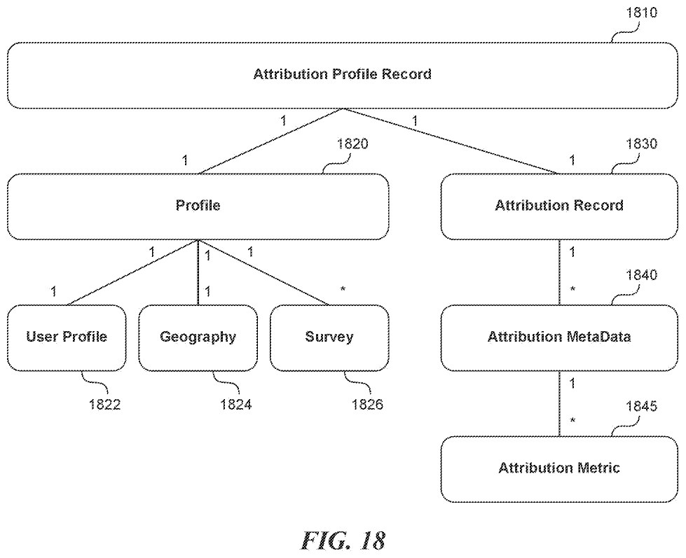

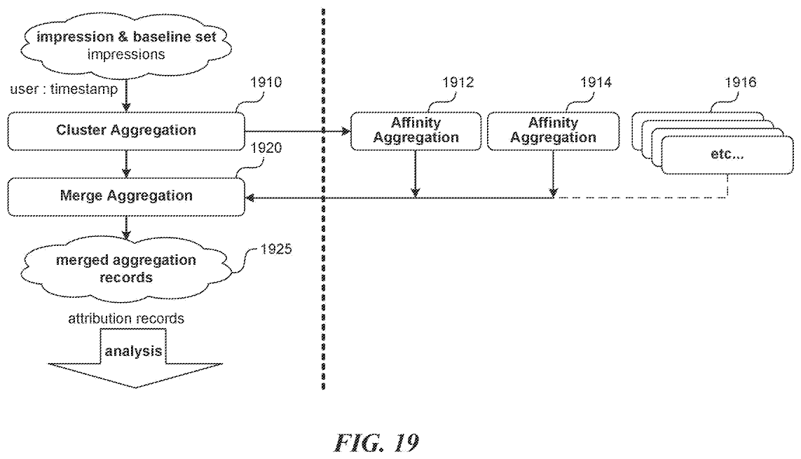

FIG. 18 is a block diagram illustrating an example of an attribution data model of the attribution system. In FIG. 18, the attribution profile record 1810 is created by joining profile and attribution record as described with reference to FIG. 16. The profile 1820 includes user profile 1822, geography 1824, and survey data 1826. The attribution record 1830 stores associations between user id and population (e.g., baseline or impression) and is associated with a set of attribution metadata 1840. Examples of the attribution metadata include, but are not limited to: impression-timestamp, event-type, event-id, window-start, window-end and analysis-tag. Each attribution record, for a given set of attribution metadata, is also associated with one or more of the attribution metrics 1845 listed in Table 1 above.

FIG. 19 is a block diagram illustrating flexible metric aggregation in the attribution system 110. Various metrics from cluster aggregation 1910, affinity aggregation 1912, casual aggregation 1914, and other metrics 1916 can be merged 1920 resulting in merged aggregation records 1925. As additional aggregation methods are added or deleted, the aggregation records can be updated without making any changes to the attribution data model or other components of the attribution system. The merged aggregation records created from the merging of aggregation results provide the attribution records used in the attribution analysis 1930 by the core pipeline.

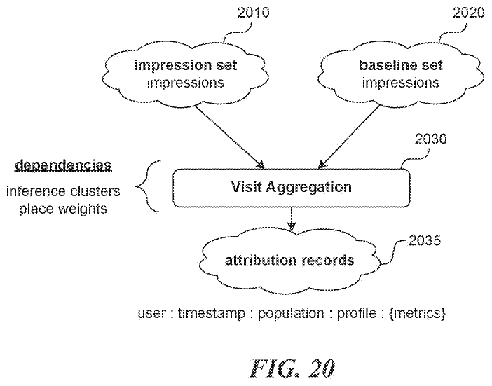

Various type of aggregations performed by the core pipeline will now be described. FIG. 20 is a block diagram illustrating user visit or cluster data aggregation. Using inference cluster visit data including place weights, the core pipeline can determine the visit metrics of the impression 2010 and baseline users 2020. The inference cluster visit data is determined by an inference pipeline that is described in detail in U.S. Pat. No. 8,768,876. The inference pipeline takes raw location and sensor readings from a device of a user as input and generates probabilities that the user visited a target place (e.g., p_target) or anywhere else (e.g., p_anywhere). The inference pipeline can also determine other visit data such as cluster_count for the impression and baseline users and determine or infer other visitation data such as visitor_days_target and visitor_days_anywhere. The results from the cluster or visit aggregation analysis 2030 are stored in cluster attribution records 2035, which are eventually merged with other types of attribution records to form the attribute profile records as described before. A cluster attribution record stores association between a user id, timestamp, population (baseline or impression), profile and metrics (e.g., visit metrics, for example, p_target, p_anywhere, visitor_days_target, visitor_days_anywhere, cluster_count).

In some embodiments, in addition to or instead of location data collected from mobile devices, the attribution system can collect beacon data points. Some target places (e.g., stores), use beacon devices to broadcast information (e.g., information about a store) to devices using Bluetooth technology. Typically, a beacon device broadcasts a notification to any device that is within its range. In some embodiments, an application or an agent of the attribution system on a mobile device of a user can collect a beacon data point from a beacon device located at a target place. The attribution system can obtain the beacon data point from the mobile device and associate it with a device identifier. Once the beacon data point is associated with the device identifier, the attribution system can use that device identifier for matching and as confirmation that the user visited the target place.

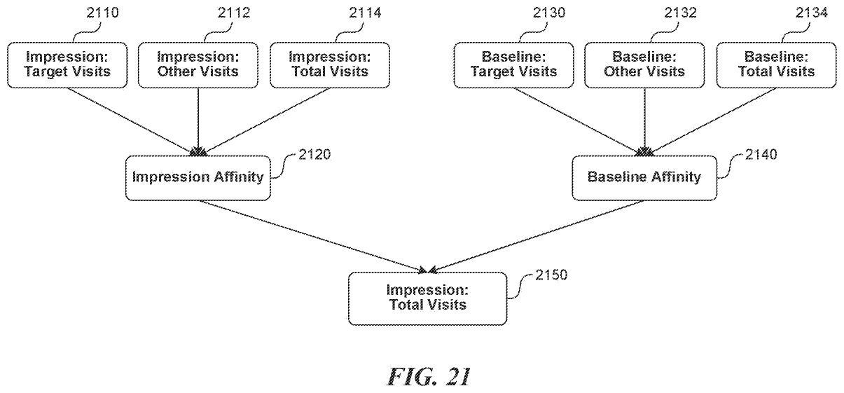

FIG. 21 is a block diagram illustrating affinity aggregation to determine an affinity index. Data associated with visits to a target place 2110 by an impression population, data associated with visits to other places 2112 by the impression population and overall total place visits 2114 by the impression population are utilized to determine impression affinity 2120 or affinity of the target place for the impression population. Further, data associated with visits to a target place 2130 by a baseline population, data associated with visits to other places 2132 by the baseline population and overall total place visits 2114 by the baseline population are utilized to determine impression affinity 2140 or affinity of the target place for the baseline population.

The affinity metric measures the likelihood that a user visits the target place, given that they are a visitor to some other place. This metric is calculated for the impression and baseline populations separately.

Based on the impression affinity and the baseline affinity, the affinity index can be determined 2150 as:

Affinity Index=(Impression Affinity/Baseline Affinity)×100

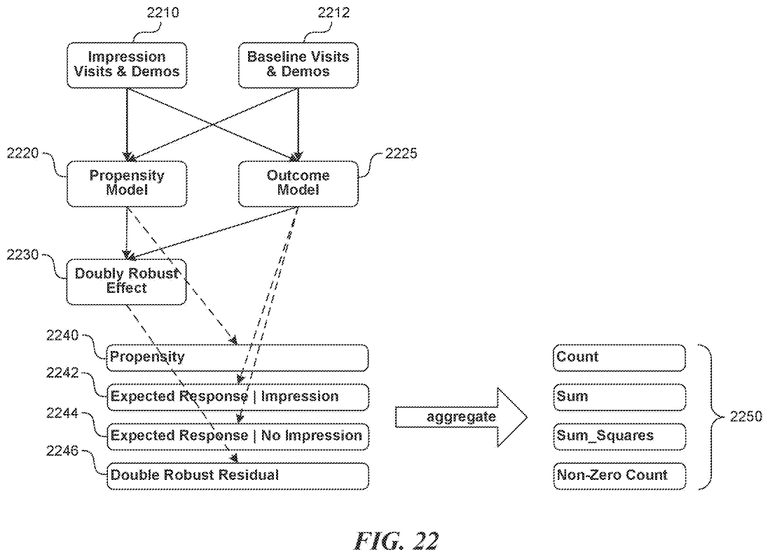

FIG. 22 is a block diagram illustrating causal aggregation to determine aggregate metrics. Results from causal aggregation allows one to make causal inference on whether place visits by the impression population are attributable or caused by exposure to the ad impressions. As described above, the propensity model 2220 weights the baseline population so that the characteristics of the baseline population match those of the impression population. Any difference in behavior between the two groups is then attributable to the exposure to the ad impression. The outcome model 2225 is another model that can be used to determine from the impression data 2210 and baseline data 2212, expected response with exposure to the ad impressions and expected response with no exposure to the ad impression. The doubly robust method 2230 of causal analysis uses a combination of the propensity model and the outcome model to estimate the causal effect of the ad impression on the place visit. The propensity model or the outcome model, if used alone, are unbiased only if the model is correct. The doubly robust effect ensures that the causal effect that is estimated is unbiased if only one of the two models is correct.

The results from these models including propensity 2240, expected response with impression 2242, expected response with no impression 2244, and double robust residual 2246 are aggregated to determine the aggregation metrics 2250 of count, sum, sum of squares and non-zero count. This set of summary metrics 2250 is sufficient to estimate the mean and variance for any aggregated metrics so that they may be subjected to standard statistical testing.

The attribution profile is unique to each user and can include information such as: user/device id, gender, location, probability of visit to the target place, number of visits to the target place or the like. Example attribution profiles are listed below:

| | | | |
|---|---|---|---|
| device-a | :male | : Seattle | : [p(t) = 0.60, visits = 2] |
| device-b | :female | : Seattle | : [p(t) = 0.30, visits = 1] |
| device-c | :male | : Portland | : [p(t) = 0.50, visits = 4 |

The process of feature aggregation, as illustrated in FIG. 23, aggregates 2310 data from the attribution profile 2305 of users across various features to generate group aggregated metrics 2320. As used herein, a feature is a characteristic of a user segment. For example, the attribution profile data shown above can be aggregated across the feature “male,” “female,” “Seattle” and “Portland” to determine the grouped aggregated metrics as shown below.

| | |
|---|---|
| male | :[size = 2 & p(t) = function(0.6, 0.5) & visits = 6] |
| female | :[size = 1 & p(t) = function(0.3) & visits = 1] |
| Seattle | :[size = 2 & p(t) = function(0.6, 0.3) & visits = 3] |
| Portland | :[size = 1 & p(t) = function(0.5) & visits = 4] |

The following example template can be used for the grouped aggregation metrics:

| | | | |
|---|---|---|---|
| SECTION | ::FEATURE | ::ATTRIBUTE | => [Aggregation Metrics] |

For example:

| | | |
|---|---|---|
| DEMOGRAPHICS ::GENDER | ::MALE | => [Aggregation Metrics] |
| DEMOGRAPHICS ::STATE | ::CALIFORNIA | => [Aggregation Metrics] |

FIG. 24 is a block diagram illustrating attribution analysis in the attribution system 110. The attribution analysis considers the grouped aggregated metrics 2410 and the match metrics 2420 as inputs and determines metrics 2430 associated with visits, ratios, lifts and indexes described above as outputs. The output data 2440 can be reported out in JSON or other suitable format.

Example store visit metrics, match metrics, lift metrics, revenue metrics, and index metrics that can be included in an attribution report are listed in tables 2-4 below.

TABLE 2
Store Visit Metrics From Attribution Analysis

| Store Visit Metries | Definition |
|---|---|
| Projected store visits over x days | Cumulative projected store visits after ad |
| | exposure, where x is a window of time |
| | determined by the attribution system model |
| Store conversion rate over x days | Average number of store conversions in the |
| | impression population |
| Cost per store visit (or other defined target) | Ratio of ad spend (reported by the advertiser) to |
| | projected store visits (or other target goal) over x |
| | days |
| Impressions per store visit ratio | Ratio of impressions (reported by the advertiser) |
| | to projected store visits over x days. |
| Purchase Rate | Ratio of purchases to store visits |
| Revenue | Revenue tied to store visits |
| Lift Revenue | Revenue tied to lifted store visits |
| Return on Ad Spend (ROAS) | Ratio of revenue to ad spend |
| Lift Return on Ad Spend | Ratio of lift revenue to ad spend |

TABLE 3
Panel Match Rate Metrics

| Panel Match Rate Metrics | Definition |
|---|---|
| Panelist with ad impression | Count of Panelists exposed to campaign ad |
| | impressions |
| Panelist impressions | Cumulative campaign ad impressions across |
| | matched users |
| Impressions per panelist | Ratio of panelist impressions to panelist |
| | with ad impression |

TABLE 4
Lift Metrics

| Lift Metrics | Definition |
|---|---|
| Confidence | A measure of the confidence that the lift is |
| | greater than zero |
| Lift | Measured difference in store visits based on |
| | targeting and ad exposure compared against |
| | baseline for panelists |
| Projected lift visits | The projected incremental store visits derived |
| | from the lift estimate |
| Cost per lift store visit (or other defined target) | Ratio of ad spend to projected lift visits |
| Impressions per lift store visit (or other defined | Ratio of impressions to projected lift visits |
| target) ratio | |

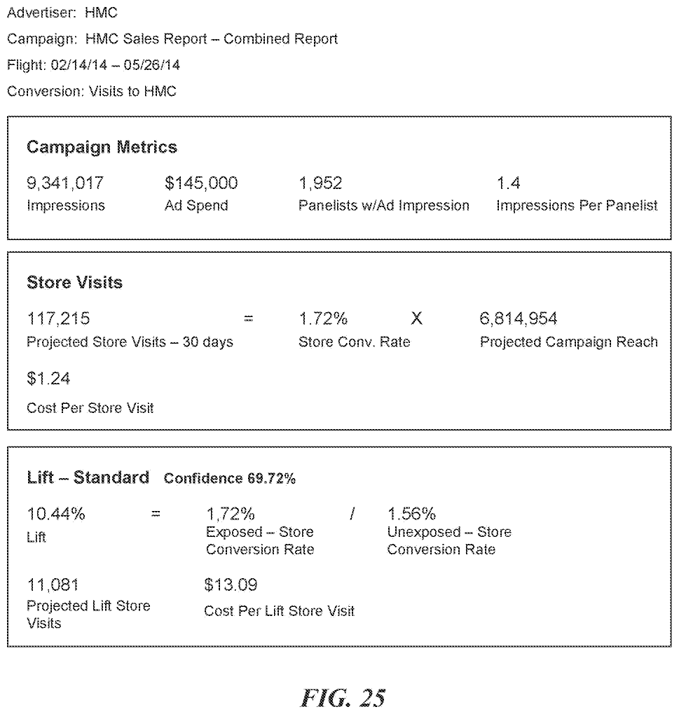

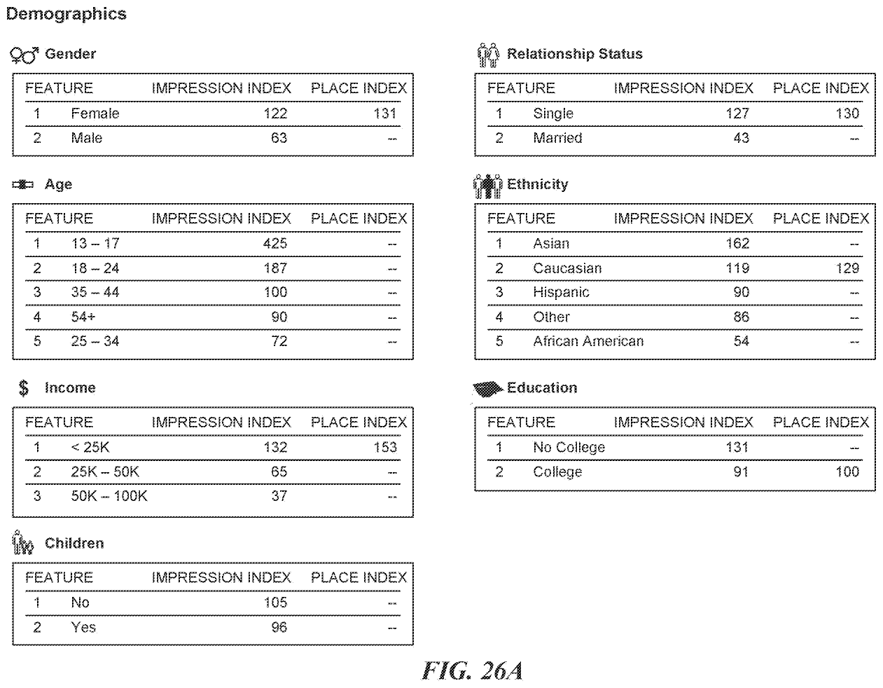

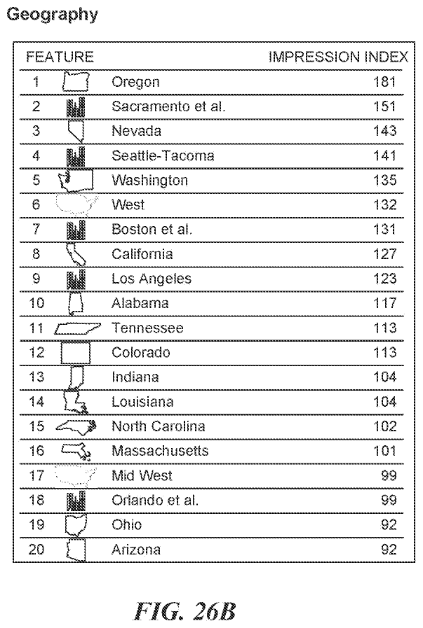

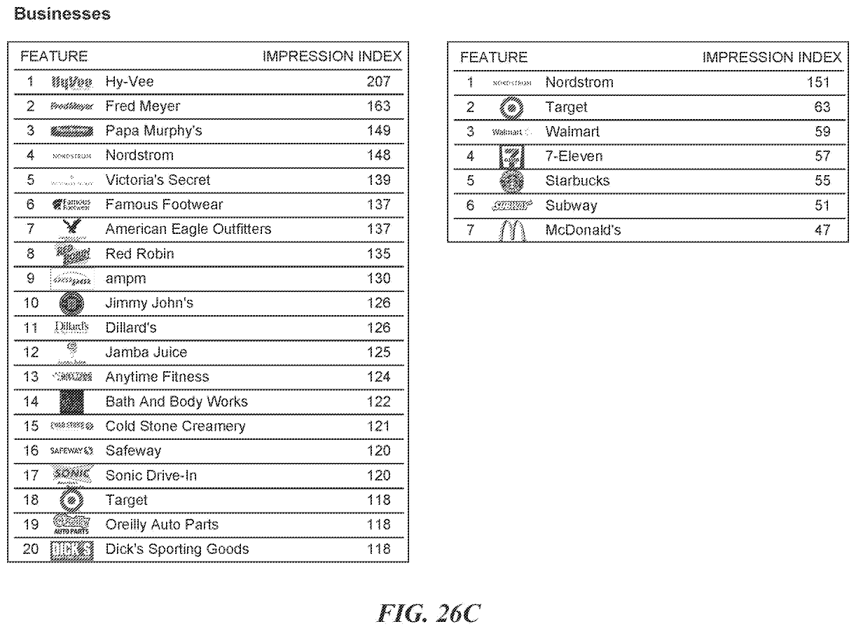

Following the attribution analysis, the attribution system 110 generates a report using aPG-report template and other configuration parameters and database configurations. FIG. 25 illustrates an example attribution report generated for an ad campaign. The attribution report includes information associated with campaign metrics. For example, a count of the impressions and amount of money spent on the ads that are provided by the advertiser can be included along with the panel match metrics listed in table 3. The attribution report also includes metrics associated with store visits and lift listed in tables 2 and 4. Referring to FIG. 26A, the attribution report can also include high index demographics features associated with the ad exposure and corresponding impression and place indexes. The indexes for different demographic features provide advertisers an overview of effectiveness of their ad campaigns in targeting different segments of the population. For example, in the gender demographic feature on the attribution report, females may over index relative to males, indicating that the ad campaign was more effective in targeting females compared to males. In some embodiments, the attribution report can also provide impression indexes for different geographic regions (FIG. 26B) and different businesses (FIG. 26C).

2c. Web Service and Database

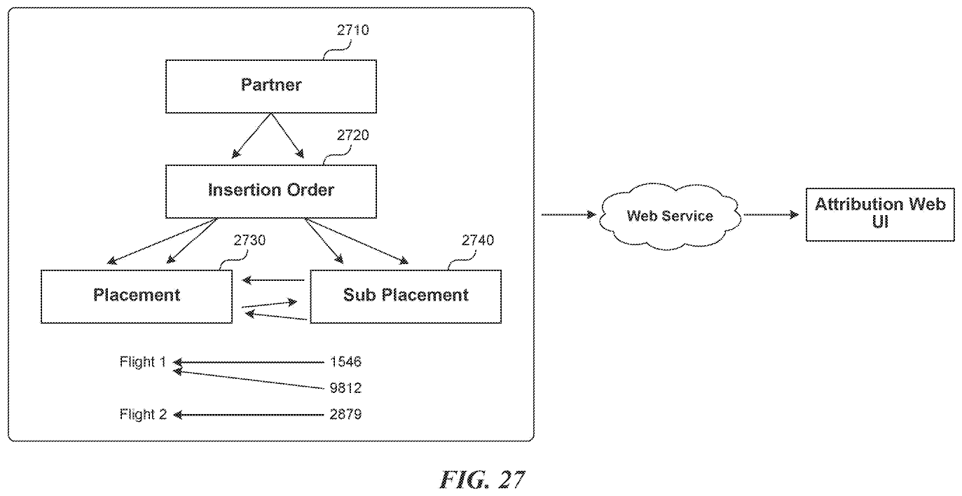

FIG. 27 is a block diagram illustrating the web service and database components of the attribution system. Typically an advertiser 2710 submits an insertion order 2720 to an ad-network to schedule and authorize an ad campaign through the ad-network. The insertion order includes information related to ad placement 2730 and sub-placement 2740. The placement information identifies the specific iteration of the ad campaign (e.g., HMC's Flight 1 or HMC's Flight 2) and the sub-placement information includes information about the ad itself. The ad campaign data are provided to the attribution system via the web service. The received campaign data is loaded and displayed on the attribution web user interface (UT). An example of ad campaign data received by the attribution system and stored in a customer database is listed in table 5.

TABLE 5
Ad Campaign Data

| Data Fields | Value |
|---|---|
| Id | 3bd3cb2b-6104-402e-b7df-68664c968479 |
| Insertion Order | ff10d359-145f-45aa-bd76-58c658f01cg6 |
| Name | HMC-GoldCinemas-ABCadnetwork |
| Start date | 2013 Dec. 26 |
| End date | 2014 Feb. 14 |
| Spend | $62,175.00 |
| Impressions | 10167842 |
| Event | 16000 |
| Event type | Place |
| Status | ACTIVE |
| Processing Status | IDLE |
| Last Processing Date | 2014 Mar. 7 00:00:00 |
| Campaign Description | HMC Gold Cinemas Report |
| Conversion Description | Visits to Gold Cinemas |
| Sub Placements | 126651390, 126652950, 126656670 |

2d. Monitoring

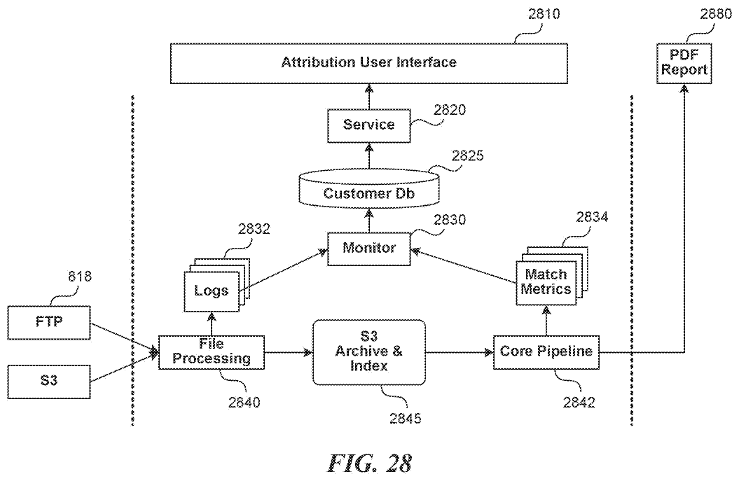

FIG. 28 is a block diagram illustrating attribution monitoring in the attribution system 110. As previously described, the impression data from ad-networks are uploaded to the FTP server 815, cloud-based storage or other file storage services. The attribution system initiates file processing 2840 to archive and index 2845 the impression data and generates logs 2832 when the archiving and indexing are completed. The core pipeline retrieves the archived and indexed impression data to determine match metrics 2834 and other aggregated metrics and generate a report 2850 (e.g., PDF report). The monitor 2830 monitors both the logs from the file processing and the match and other metrics from the core pipeline to update the customer database 2825 that stores the metrics and to generate alerts. When a customer logs in to the attribution system via the attribution user interface 2810, the attribution system, via a service 2820, uses an identifier associated with the customer to retrieve from the customer database various performance metrics and other data associated with an ad campaign associated with the customer for display on the attribution user interface.

### 3. Data Flow Through the Attribution System

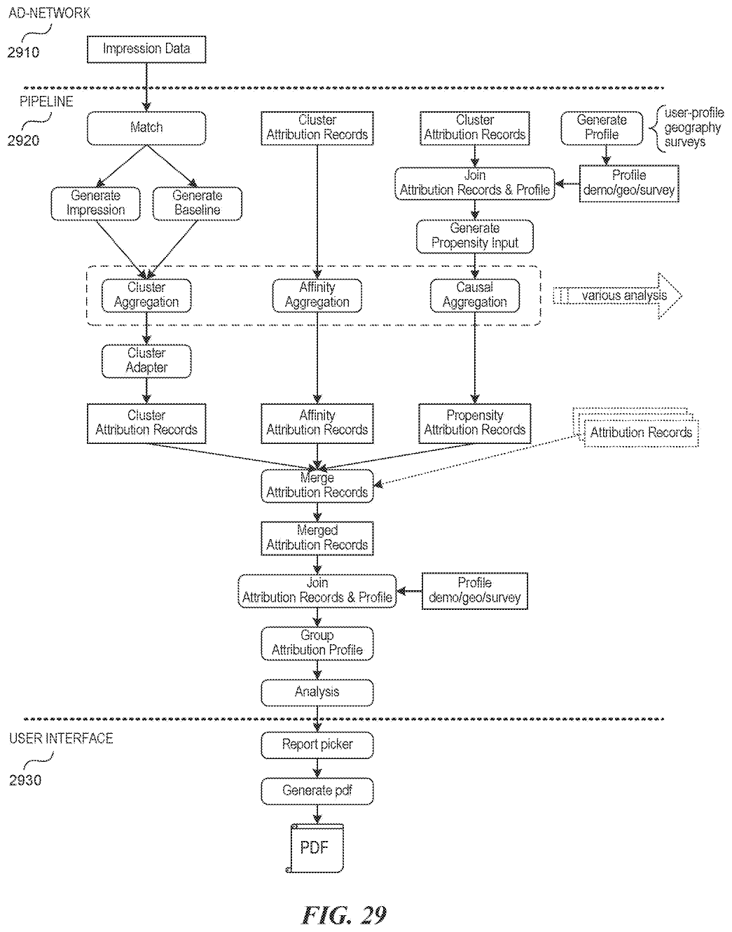

FIG. 29 is a block diagram illustrating the overall process of performing attribution analysis to generate an attribution report. An ad-network 2910 provides impression data associated with an ad campaign to the attribution system's core pipeline 2920. Typically, the ad-network is a third-party separate from the attribution system. However, in some embodiments, the impression data can be collected by an agent of the attribution system. In some other embodiments, the impression data can be derived from both third-party ad-networks and the agent of the attribution system.

In some embodiments, the impression data has been discussed in the context of ads to mobile devices. However, impression data is not limited to ads to mobile devices and may include or be associated with ad impressions for ads and/or other media (e.g., product reviews, social media) delivered to users through other media channels, for example, desktops, tablets, televisions, radio, print, billboard, or the like, to devices other than mobile devices. For example, a user's media consumption on a desktop computer, a laptop computer, or other devices may be measured and associated with a user or device identifier for attribution analysis.

The core pipeline receives the impression data and matches hashed device identifiers associated with users who received the impression against hashed device identifiers of the panelists of the attribution system to identify panelists who received the impression as impression users and panelists who did not receive the impression as baseline (if the control group is not provided by the advertiser). As described previously, panelists of the attribution system are users who have an agent or client installed on their mobile devices to report location and other observation data to an inference pipeline. The inference pipeline analyses location clusters to generate candidate places potentially visited by the users and probabilities of the visits to those candidate places. Based on the matching, the core pipeline generates impressions for the impression users and impressions for the baseline users.

The core pipeline uses the impressions associated with the impression and baseline users to perform cluster aggregation to determine visit metrics of the impression and baseline users. The visit metrics are stored in association with corresponding user, timestamp, population and profile in the cluster attribution records. The data in the cluster attribution records are utilized to perform various other analyses. For example, the core pipeline utilizes data in the cluster attribution records to perform affinity aggregation to generate affinity index. Similarly, the core pipeline utilizes the data in the cluster attribution record to generate merged profile which associates user profile, geography and surveys. The core pipeline then joins the cluster attribution records and the profile and uses that information to generate propensity input for a propensity model. The propensity input in some embodiments can be visits and demographics associated with impression users and baseline users. Demographics can include, for example, age, geography and/or other attributes.

The core pipeline then performs causal aggregation by feeding the merged profiles into a propensity model. The propensity model utilizes the propensity input data to generate a propensity score that weights the baseline users so that the demographic, geographic and/or other behavioral characteristics of the baseline users match those of the impression users. The propensity model is combined with an outcome model to obtain doubly robust estimate, though any number of propensity modeling techniques may be used. The outputs from the causal analysis are aggregated across the various aggregation dimensions (e.g., demographics, geography) to determine count, sum, sum of squares and non-zero count and stored as propensity attribution records. The cluster, affinity, causal and/or other attribution records are merged together to obtain merged attribution records. The core pipeline then uses demography, geography and survey associated with profiles to obtain group attribution profile.

The core pipeline then performs an attribution analysis to determine the performance metrics including visit metrics, lift metrics and indexes and stores such performance metrics as report data. In some embodiments, a customer can access a user interface provided by the attribution system to pick a report associated with the ad campaign for processing. Once a report is picked up for processing, the attribution system uses the report data to generate a report or update a previously generated report and provides the report to the customer via the user interface 2930. The report can be in any suitable format such as PDF, XLS, CSV or the like.

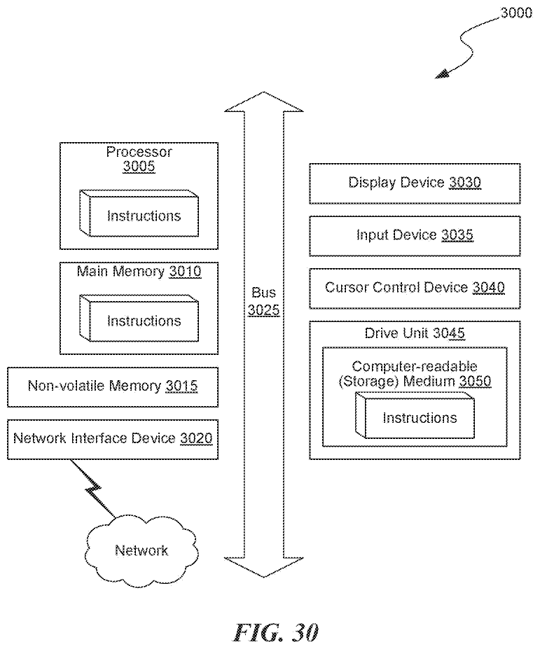

FIG. 30 shows a diagrammatic representation of a machine in the example form of a computer system within which a set of instructions, for causing the machine to perform any one or more of the methodologies discussed herein, may be executed.

In the example of FIG. 30, the computer system 3000 includes a processor 3005, main memory 3010, non-volatile memory 3015, and an interface device 3020. Various common components (e.g., cache memory) are omitted for illustrative simplicity. The computer system 3000 is intended to illustrate a hardware device on which any of the components depicted in the example of FIGS. 8-12 and 28 (and any other components described in this specification) can be implemented. The computer system 3000 can be of any applicable known or convenient type. The components of the computer system 3000 can be coupled together via a bus or through some other known or convenient device.

The processor 3005 may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory 3010 is coupled to the processor by, for example, a bus 3025. The memory can include, by way of example but not limitation, random access memory (RAM), such as dynamic RAM (DRAM) and static RAM (SRAM). The memory can be local, remote, or distributed.

The bus 3025 also couples the processor to the non-volatile memory 3015 and drive unit 3045. The non-volatile memory 3015 is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 3000. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache. Ideally, this serves to speed up execution. As used herein, a software program is assumed to be stored at any known or convenient location (from non-volatile storage to hardware registers) when the software program is referred to as “implemented in a computer-readable medium 3050.” A processor is considered to be “configured to execute a program” when at least one value associated with the program is stored in a register readable by the processor.

The bus 3025 also couples the processor to the network interface device 3020. The interface can include one or more of a modem or network interface. It will be appreciated that a modem or network interface can be considered to be part of the computer system. The interface can include an analog modem, isdn modem, cable modem, token ring interface, satellite transmission interface (e.g., “direct PC”), or other interfaces for coupling a computer system to other computer systems. The interface can include one or more input 3035 and/or output devices. The I/O devices can include, by way of example but not limitation, a keyboard, a mouse or other pointing device 3040, disk drives, printers, a scanner, and other input and/or output devices, including a display device 3030. The display device can include, by way of example but not limitation, a cathode ray tube (CRT), liquid crystal display (LCD), or some other applicable known or convenient display device. For simplicity, it is assumed that controllers of any devices not depicted in the example of FIG. 30 reside in the interface.

In operation, the computer system 3000 can be controlled by operating system software that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments of the attribution system have been described herein for purposes of illustration, but that various modifications may be made without deviating from the spirit and scope of the embodiments. Accordingly, the embodiments are not limited except as by the appended claims.

We claim:

1. A computer-implemented method of analyzing an impact of media consumption on visitation behavior, the method comprising:
receiving impression data associated with consumption of media relating to a campaign, the impression data including unique identifiers associated with a first set of users who consumed the media relating to the campaign;
comparing the unique identifiers associated with the first set of users against a second set of users to identify a set of users who are among both the first set of users and the second set of users as impression users; and
identifying a subset of the second set of users who are not among the first set of users as baseline users,
determining, based on one or more analyses of the impression data associated with the impression users and impression data associated with the baseline users, whether the consumption of the media influenced the impression users to visit a target place during a window of time.

2. The method of claim 1, further comprising determining, based on the one or more analyses of the impression data associated with the impression users and the impression data associated with the baseline users whether the consumption of the media relating to the campaign influenced the impression users to visit the target place at a higher rate compared to the baseline users during the window of time.

3. The method of claim 2, wherein the window of time is relative to the media consumption by a user.

4. The method of claim 1, wherein the unique identifiers include one of: device identifiers or device-related identifiers.

5. The method of claim 1, wherein the impression data further comprises an identifier for determining what the media relating to the campaign that was consumed was about and a timestamp that indicates when the media relating to the campaign was consumed.

6. The method of claim 1, wherein the one or more analyses utilize location and other activity information associated with the impression users to determine whether the impression users visited the target place over the window of time and probabilities of the visit to the target place.

7. The method of claim 1, further comprising:
determining a propensity score using a propensity model based on data associated with the impression and baseline users; and
adjusting the baseline users using the propensity score to match the impression users.

8. The method of claim 7, further comprising:
calculating a conversion rate for the baseline users;
calculating a conversion rate for the impression users; and
calculating a conversion rate for the baseline users after the adjustment using the propensity score.

9. The method of claim 8, wherein calculating the conversion rate for the impression users further comprises attributing a visit to the target place by an impression user to one or more instances of consumption of the media relating to the campaign.

10. The method of claim 8, further comprising:
calculating an impact of targeting the media relating to the campaign to a set of users and the impact of the consumption of the media on the visitation behavior based on the conversion rates of the baseline and impression users.

11. The method of claim 8, further comprising:
calculating an impact of targeting the media to a set of users based on the conversion rate of the baseline users after the adjustment using the propensity score and the conversion rate of the baseline users without the adjustment.

12. The method of claim 8, further comprising:
calculating the impact of only the media on the visitation behavior based on the conversion rate of the baseline users after the adjustment using the propensity score and the conversion rate of the impression users.

13. The method of claim 1, further comprising:
identifying, from the impression users, a first group of users associated with a demographic, behavioral or geographic feature;
identifying, from the baseline users, a second group of users associated with a demographic, behavioral, or geographic feature; and
calculating an impression index for the demographic or geographic feature based on a difference between in population between the first and second groups of users.

14. The method of claim 1, further comprising:
identifying, from the impression users, a first group of users associated with a demographic or geographic feature and visits to the target place during the window of time;
identifying, from the baseline users, a second group of users associated with a demographic or geographic feature and visits to the target place during the window of time; and
calculating a place index for the demographic or geographic feature based on a difference between in population between the first and second groups of users who visited the target place.

15. The method of claim 1, further comprising:
identifying, from the impression users, a first group of users associated with a demographic, behavioral, device, or geographic feature;
identifying, from the baseline users, a second group of users associated with a demographic, behavioral, device, or geographic feature; and
calculating, based on populations of the first and second group of users, one or more indexes that provide targeting information for the campaign or a next campaign.

16. The method of claim 15, wherein the one or more indexes includes an opportunity index, wherein the targeting information provided by the opportunity index includes a demography, behavior, device or geography to be targeted in the next campaign.

17. A tangible computer-readable storage medium whose contents, when executed by a computing device, cause the computing device to perform operations for attributing a conversion event to a campaign, the operations comprising:
receiving an indication that a mobile device has entered a target geographical location associated with the campaign; and
determining a campaign impression for the campaign occurred at the mobile device within a certain time period before the mobile device entered the target location.

18. The tangible computer-readable medium of claim 17, wherein the certain time period is based on a location type of the target geographical location.

19. The tangible computer-readable medium of claim 17, wherein receiving an indication that a mobile device has entered a target geographical location associated with the campaign includes determining the mobile device has entered the target geographical location based on accessing GPS data associated with the mobile device; and wherein determining a campaign impression for the campaign occurred at the mobile device within a certain time period before the mobile device entered the target location includes accessing impression data associated with the campaign for campaign impressions performed at multiple mobile devices during the campaign.

20. An attribution system, comprising:
an impression component that receives campaign impression data associated with media consumption at multiple mobile devices during a campaign;
a location visit component that determines whether one or more of the multiple mobile devices visit a geographical location associated with the campaign within a time window for the campaign; and
an attribution component that identifies occurrences of conversion events for the campaign when the one or more mobile devices visit the geographical location associated with the campaign within the time window for the campaign.
